(19) United States
(12) Patent Application Publication
(10) Pub. No.: US 2024/0253153 A1
(43) Pub. Date: Aug. 1, 2024

(54) LASER PROCESSING APPARATUS AND LASER PROCESSING METHOD

(71) Applicants: KOMATSU INDUSTRIES CORPORATION, Kanazawa-shi, Ishikawa (JP); FURUKAWA ELECTRIC CO., LTD., Chiyoda-ku, Tokyo (JP)

(72) Inventors: Seiichi HAYASHI, Komatsu-shi, Ishikawa (JP); Kosuke KASHIWAGI, Chiyoda-ku, Tokyo (JP)

(73) Assignees: KOMATSU INDUSTRIES CORPORATION, Kanazawa-shi, Ishikawa (JP); FURUKAWA ELECTRIC CO., LTD., Chiyoda-ku, Tokyo (JP)

(21) Appl. No.: 18/290,497

(22) PCT Filed: May 11, 2022
(86) PCT No.: PCT/JP2022/019878

§ 371 Date: Nov. 14, 2023

(30) Foreign Application Priority Data
May 28, 2021 (JP) 2021-090382

(51) Int. Cl. B23K 26/06; B23K 26/38; B23K 103/04; G02B 6/42

(52) U.S. Cl. CPC B23K 26/0608; B23K 26/38; B23K 2103/04; G02B 6/4207

(57) ABSTRACT

A feeding fiber cable collectively extracts laser light generated by each of a plurality of fiber laser engines. A processing head converges and emits laser light to a workpiece. A process fiber cable transmits the laser light extracted by the feeding fiber cable to the processing head. The core diameter of the feeding fiber cable and that of the process fiber cable are equal and 50 μm. The plurality of fiber laser engines each have a filter that reduces a value of Raman scattered light in the laser light.

### TECHNICAL FIELD

The present disclosure relates to a laser processing apparatus and a laser processing method.

### BACKGROUND ART

A conventionally known fiber laser processing machine performs processing such as cutting a workpiece by irradiating it with laser light. Such a fiber laser processing machine is disclosed for example in Japanese Patent No. 6251684 (see PTL 1). PTL 1 discloses that a feeding fiber cable and a process fiber cable have equal core diameters of 50 μm.

### CITATION LIST

### Patent Literature

[PTL 1] Japanese Patent No. 6251684

### SUMMARY OF INVENTION

### Technical Problem

For example, in cutting a soft thick steel plate, oxygen gas is used as an assist gas, and a cutting process is performed by utilizing heat of oxidation reaction. When oxygen gas is used as an assist gas, however, oxidation reaction rate serves as a rate-determining factor, and it is thus difficult to increase speed of processing such as cutting. Therefore, for a thin plate which disfavors generation of oxide film on a cut surface, an inert gas (such as nitrogen gas, argon gas, or the like) may be used as an assist gas. In that case, in order to improve a processing speed, there is a method, that is, laser light's spot diameter is reduced to increase power density. In order to reduce the spot diameter, it is necessary to reduce a process fiber's core diameter and narrow the laser light by a conversing lens.

However, there is a problem, that is, it is difficult to increase a processing speed even when the core diameter is reduced as described in PTL 1.

It is an object of the present disclosure to provide a laser processing apparatus and method that facilitate processing at a high processing speed.

### Solution to Problem

As a result of a diligent investigation, the present inventors have found that a processing speed becomes slower when Raman scattered light generated inside a fiber has a larger value, and the present inventors have thus reached the present disclosure.

A laser processing apparatus according to the present disclosure is a laser processing apparatus that processes a workpiece made of a metal material, and comprises a plurality of fiber laser engines, a feeding fiber cable, a processing head, and a process fiber cable. The feeding fiber cable collectively extracts laser light generated by each of the plurality of fiber laser engines. The processing head converges laser light for a workpiece and thus emits the laser light. The process fiber cable transmits the laser light that is extracted by the feeding fiber cable to the processing head. The feeding fiber cable and the process fiber cable have equal core diameters of 50 μm. The plurality of fiber laser engines each have a filter that reduces a value of Raman scattered light in the laser light.

A laser processing method of the present disclosure is a laser processing method for processing a workpiece made of a metal material using the laser processing apparatus. The laser processing method of the present disclosure employs laser light having a wavelength of a 1 μm band, and an assist gas that is an inert gas, and processes the workpiece at a processing point with a spot diameter of 60 μm or more and 150 μm or less.

### Advantageous Effects of Invention

According to the present disclosure, a laser processing apparatus and a laser processing method that facilitate processing at a high processing speed can be implemented.

### BRIEF DESCRIPTION OF DRAWINGS

FIG. 1 is a perspective view of a configuration of a laser processing apparatus according to an embodiment.

FIG. 2 is a diagram showing a configuration of a laser light emitting mechanism (a unifocal lens) in the laser processing apparatus of FIG. 1.

FIG. 3 is a diagram showing a connection structure for a feeding fiber cable and a process fiber cable in the laser processing apparatus of FIG. 1.

FIG. 4 is a diagram showing a configuration of a laser light emitting mechanism (beam diameter control) in the laser processing apparatus of FIG. 1.

FIG. 5 is a diagram showing a configuration of a fiber laser engine in FIG. 2 or 4.

FIG. 6 is a diagram for illustrating a fiber Bragg grating used for a filter for Raman scattered light.

FIG. 7 is a diagram for illustrating that a specific wavelength component is reflected by the fiber Bragg grating of FIG. 6.

FIG. 8 is a flowchart of a laser processing method according to an embodiment.

FIG. 9 is a diagram showing a relationship between laser power at each focal point position and speed of cutting a workpiece when Raman scattered light at a processing point has a value of −25 dB.

FIG. 10 is a diagram showing a relationship between laser power at each focal point position and speed of cutting a workpiece when Raman scattered light at a processing point has a value of −30 dB.

FIG. 11 is a diagram for illustrating a method for measuring a value of Raman scattered light at a processing point.

FIG. 12 represents a relationship between a value of Raman scattered light at a processing point and height of burr produced at a workpiece.

FIG. 13 represents a relationship between laser light's focal point position and height of burr produced at a workpiece.

FIG. 14 is a diagram for illustrating a relationship between a workpiece's thickness and laser light's focal point position.

### DESCRIPTION OF EMBODIMENTS

Hereinafter, an embodiment of the present disclosure will more specifically be described with reference to the accompanying drawings. In the specification and drawings, identical or corresponding components are identically denoted and will not be described redundantly. In the drawings, configuration may be omitted or simplified for convenience of description.

### <Configuration of Laser Processing Apparatus>

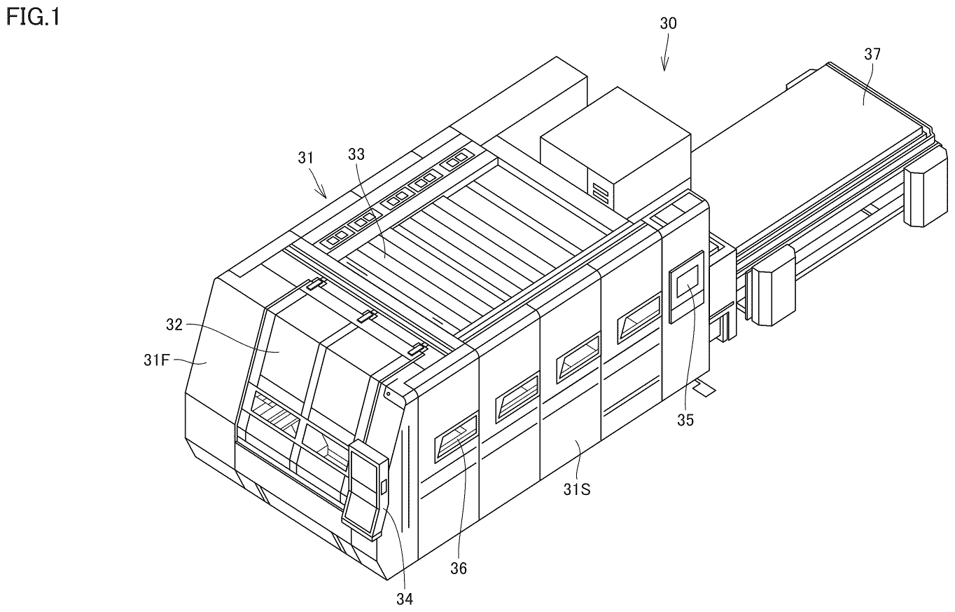

A configuration of a laser processing apparatus according to the present embodiment will now be described with reference to FIG. 1.

FIG. 1 is a perspective view of a configuration of a laser processing apparatus according to one embodiment. As shown in FIG. 1, a laser processing apparatus 30 of the present embodiment processes a workpiece made for example of a metal material. Laser processing apparatus 30 comprises a cabin 31 and a pallet changer 37.

Cabin 31 includes a gull wing door 32, an openable and closable ceiling door 33, a first console panel 34, a second console panel 35, and a plurality of monitoring windows 36.

Gull wing door 32 is provided at a front surface 31F of cabin 31. At a rear surface of cabin 31 opposite to front surface 30F, a loading/unloading port (not shown) formed in a horizontally long slit is provided so as to correspond to pallet changer 37. When a large lot of products is processed, a pallet with workpieces placed thereon is loaded/unloaded through the loading/unloading port. When a small lot of products is processed, workpieces are loaded/unloaded through gull wing door 32. In this way, a loading/unloading operation corresponding to a lot size can be performed.

Openable and closable ceiling door 33 is disposed at a ceiling of cabin 31. First console panel 34 is disposed on front surface 31F of cabin 31 sideways of gull wing door 32. Second console panel 35 is disposed on a side surface 31S of cabin 31 closer to the rear surface. The plurality of monitoring windows 36 are disposed at side surface 31S of cabin 31. An interior of cabin 31 can be visually observed outside of cabin 31 through each of the plurality of monitoring windows 36.

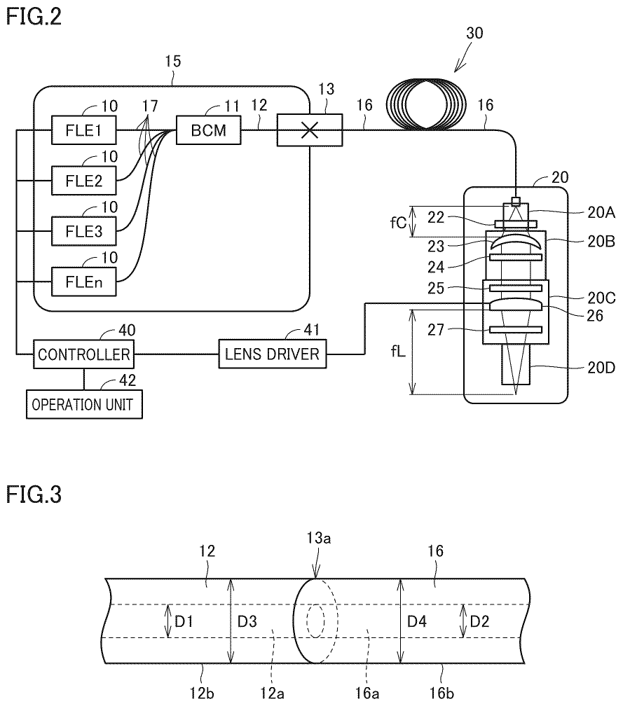

Laser processing apparatus 30 further comprises a fiber laser oscillator 15 (FIG. 2), a processing head 20 (FIG. 2), an assist gas supply unit (not shown), a chiller unit (not shown), and a dust collector (not shown).

Fiber laser oscillator 15 oscillates laser light. Processing head 20 converges the laser light oscillated by fiber laser oscillator 15 and thus emits the converged laser light to a workpiece. Thus, processing head 20 processes the workpiece.

The assist gas supply unit blows an assist gas to the workpiece. The assist gas is blown to molten pool of the workpiece that is made by irradiation with laser light to remove material. An inert gas (nitrogen gas, argon gas, or the like), oxygen gas, or the like is used as the assist gas. The assist gas supply unit includes a booster compressor or the like.

The chiller unit supplies coolant water to fiber laser oscillator 15 and processing head 20. Thus, fiber laser oscillator 15 and processing head 20 are cooled. The dust collector eliminates dust generated during processing from a processed portion.

### <Laser Light Emitting Mechanism of Laser Processing Apparatus>

A configuration of a laser light emitting mechanism in the laser processing apparatus of the present embodiment shown in FIG. 1 will now be described with reference to FIGS. 2 to 4.

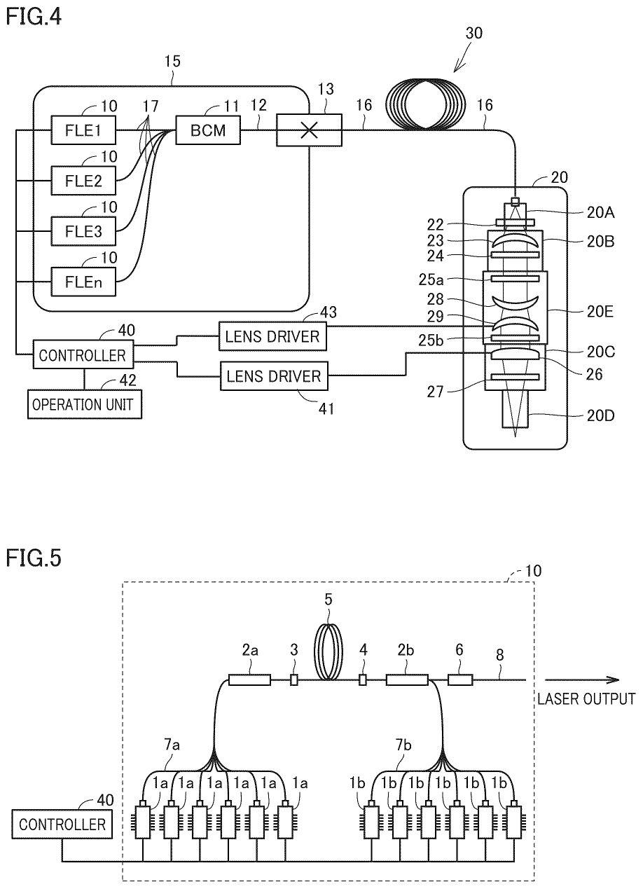

FIGS. 2 and 4 each show a configuration of a laser light emitting mechanism in the laser processing apparatus of FIG. 1. FIG. 3 is a diagram showing a connection structure for a feeding fiber cable and a process fiber cable in the laser processing apparatus of FIG. 1.

As shown in FIG. 2, laser processing apparatus 30 of the present embodiment comprises fiber laser oscillator 15, a process fiber cable 16, processing head 20, a controller 40, a lens driver 41, and an operation unit 42.

Fiber laser oscillator 15 includes a plurality of fiber laser engines 10, a plurality of delivery optical fibers 17, a beam combiner module 11, a feeding fiber cable 12, and a splice box 13.

The plurality of fiber laser engines 10 each output laser light. Fiber laser oscillator 15 for example includes six fiber laser engines 10. The six fiber laser engines 10 each have a laser light output for example of 1.5 kW. In that case, fiber laser oscillator 15 will have a capacity for example of 9 kW as maximum power.

The plurality of delivery optical fibers 17 are each connected to a respective one of the plurality of fiber laser engines 10. The plurality of delivery optical fibers 17 are connected to a single feeding fiber cable 12 by beam combiner module 11. Thus, laser lights output from the plurality of fiber laser engines 10 are combined by beam combiner module 11 and subsequently transmitted through feeding fiber cable 12.

Feeding fiber cable 12 is bonded to process fiber cable 16 in a splice box 13.

As shown in FIG. 3, feeding fiber cable 12 includes a core 12a and a cladding layer 12b covering an outer circumference of core 12a. Process fiber cable 16 includes a core 16a and a cladding layer 16b covering an outer circumference of core 16a.

Feeding fiber cable 12 and process fiber cable 16 have the same core diameter. A diameter D1 of core 12a of feeding fiber cable 12 and a diameter D2 of core 16a of process fiber cable 16 are each for example 50 μm.

Feeding fiber cable 12 and process fiber cable 16 having equal core diameter D1 and D2 are bonded together for example by fusion bonding. Feeding fiber cable 12 and process fiber cable 16 are preferably connected together concentrically with respect to each other.

While feeding fiber cable 12 and process fiber cable 16 may have the same core diameter at a fused portion 13a, feeding fiber cable 12 and process fiber cable 16 preferably have uniform core diameters D1 and D2 in directions in which their respective optical fibers extend. This can suppress reduction in luminance caused by a difference between core diameters D1 and D2 and improve beam quality without specially processing feeding fiber cable 12 and process fiber cable 16.

In the present specification, when fiber cables 12 and 16 have core diameters D1 and D2, respectively, in a distribution within a range of ±10% or less, fiber cables 12 and 16 are assumed to each have a uniform core diameter. For example, when feeding fiber cable 12 (or process fiber cable 16) has core diameter D1 (or D2) of 50±5 μm along its entire length, feeding fiber cable 12 (or process fiber cable 16) is assumed to have a uniform core diameter. Accordingly, in the present specification, core diameters D1 and D2 each being 50 μm means that core diameters D1 and D2 are each 50±5 μm along its entire length.

A fusion process is performed by disposing feeding fiber cable 12 and process fiber cable 16 with their respective end surfaces facing and abutting against each other, and thus heating the end surfaces. While this fusion process can be performed using an optical fiber fusion splicer, it is preferably performed using a core alignment fusion splicer excellent in core alignment performance. Performing a fusion process using an optical fiber fusion splicer allows process fiber cable 16 having a smaller core diameter than conventional to be used. Further, connecting together fiber cables 12 and 16 having small core diameters D1 and D2 can reduce laser light's spread angle and allows an increased cutting speed (or processing speed).

Diameters D3 and D4 of cladding layers 12b and 16b, respectively, are not particularly limited. Diameter D3 of cladding layer 12b and diameter D4 of cladding layer 16b may be equal or different.

As shown in FIG. 2, process fiber cable 16 has a length for example of 20 m. Process fiber cable 16 is connected to processing head 20. Processing head 20 includes a connector unit 20A, a collimator unit 20B, a lens unit 20C, and a nozzle unit 20D.

Connector unit 20A is a portion that connects process fiber cable 16 to processing head 20. Process fiber cable 16 connected to connector unit 20A emits laser light into processing head 20.

Collimator unit 20B is a portion that collimates the laser light emitted from process fiber cable 16 into processing head 20. Collimator unit 20B includes a collimator lens 23 that collimates the laser light.

Lens unit 20C is a portion that converges the collimated laser light. Lens unit 20C includes a conversing lens 26 that converges the collimated laser light. Conversing lens 26 is movable by a lens driver 41 along the optical axis of the laser light.

Lens driver 41 is for example a servo motor. By moving conversing lens 26 along the optical axis of the laser light, the laser light's focal point position can be moved along the optical axis. This can change the laser light's focal point position with respect to the workpiece.

Nozzle unit 20D is a portion that emits the converged laser light toward the workpiece. Nozzle unit 20D has a laser emitting port with a gap of a predetermined distance between the laser emitting port and the workpiece. Nozzle unit 20D has a gas blowing port (not shown) for blowing an assist gas toward the workpiece.

Furthermore, processing head 20 has protective glasses 22, 24, 25 and 27. Protective glass 22 is disposed near an outlet of connector unit 20A. Protective glass 24 is disposed in collimator unit 20B on a side of collimator lens 23 closer to lens unit 20C. Protective lenses 25 and 27 are disposed in lens unit 20C and sandwich conversing lens 26 in the direction of the optical axis of the laser light.

Controller 40 limits an oscillation output at each of the plurality of fiber laser engines 10 based on the length of process fiber cable 16 so that Raman scattered light at a processing point of the workpiece has a value of −30 dB or less. The length of process fiber cable 16 may be input for example from operation unit 42 to controller 40 by an operator. Operation unit 42 may for example be one of first console panel 34 and second console panel 35.

The Raman scattered light at the processing point of the workpiece has a value increasing in proportion to the length of process fiber cable 16 and the oscillation output. Accordingly, the oscillation output at each of the plurality of fiber laser engines 10 is limited so that the Raman scattered light has a value of −30 dB or less. For example, via operation unit 42, the operator limits a value input to controller 40. Operation unit 42 may for example be one of first console panel 34 and second console panel 35.

For example, to allow the Raman scattered light at the processing point to have a value of −30 dB or less while using process fiber cable 16 having a length of 20 m, the output of fiber laser oscillator 15 is limited for example to 8 kW.

Furthermore, based on a type of processing, controller 40 selects among the plurality of fiber laser engines 10 fiber laser engine 10 which causes laser light to oscillate and fiber laser engine 10 which does not cause laser light to oscillate. The type of processing may be input by the operator via operation unit 42 to controller 40, for example.

For example, when the type of processing is cutting a workpiece or the like, controller 40 controls fiber laser engines 10 to all oscillate. When the type of processing is for example scribing the workpiece or marking on a surface of the workpiece, controller 40 causes only some of fiber laser engines 10 to oscillate and does not cause the remaining fiber laser engine or engines to oscillate to thus provide limited oscillation output.

Furthermore, controller 40 controls lens driver 41 to drive it based for example on the thickness of the workpiece. This controls the position of conversing lens 26 along the optical axis of the laser light so that the laser light's focal point position is an optimal position with respect to the workpiece. The thickness of the workpiece may be input by the operator via operation unit 42 to controller 40, for example. The laser light's focal point position is set for example at any position between a surface of the workpiece and the center in thickness of the workpiece.

Thus, the laser light's focal point position can be adjusted depending on the material of the workpiece, the type of the assist gas, or the thickness of the workpiece.

While processing head 20 using a unifocal lens has been described above, processing head 20 may be configured to be capable of controlling the laser light's beam diameter. In that case, as shown in FIG. 4, processing head 20 includes a beam diameter control unit 20E. Beam diameter control unit 20E includes two lenses 28 and 29. For example, the laser light's beam diameter can be adjusted by moving lens 29 relative to lens 28 along the optical axis of the laser light.

In the FIG. 4 configuration for example lens 29 is movable along the optical axis of the laser light by a lens driver 43. Lens driver 43 is for example a servo motor. Lens driver 41 is driven in response to a command received from controller 40 to move lens 29 along the optical axis of the laser light.

Adjusting the beam diameter consequently adjusts a spot diameter converged by conversing lens 26 (a converged diameter). The spot diameter at the processing point of the workpiece is adjusted for example to 60 μm or more and 150 μm or less.

When the assist gas is oxygen gas, or an inert gas and oxygen gas alternately switched, it is preferable to adjust the laser light's beam diameter. When the assist gas is limited to an inert gas (e.g., nitrogen gas), it is unnecessary to adjust the laser light's beam diameter. Therefore, in that case, as shown in FIG. 2, processing head 20 without beam diameter control unit 20E (FIG. 4) is used.

### <Configuration of Fiber Laser Engine>

Hereinafter, a configuration of the fiber laser engine of the present embodiment will be described with reference to FIGS. 5 to 7.

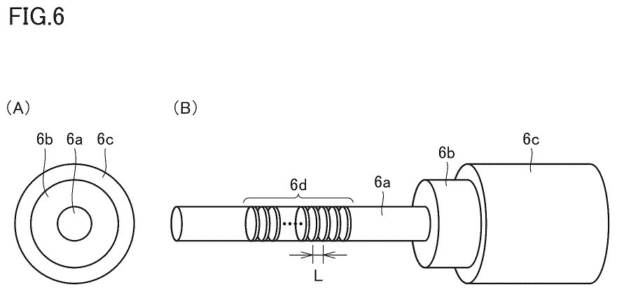

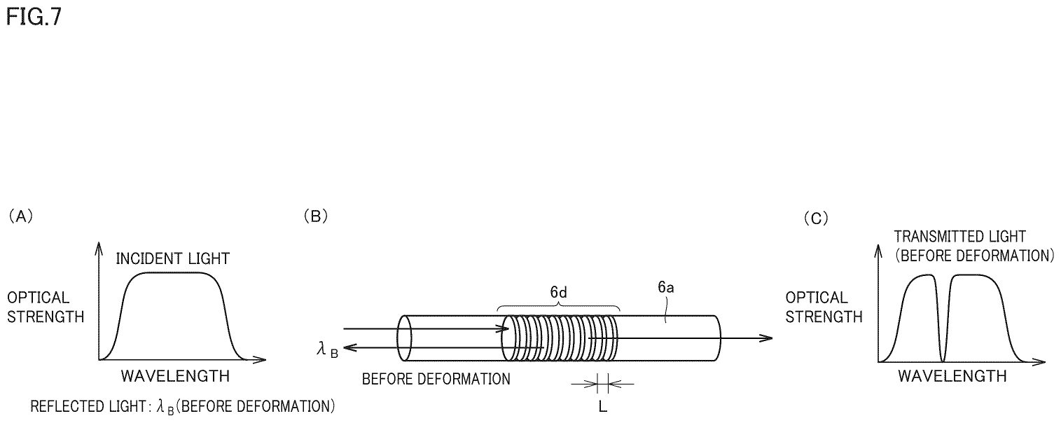

FIG. 5 is a diagram showing a configuration of the fiber laser engine shown in FIG. 2 or 4. FIG. 6 is a diagram for illustrating a fiber Bragg grating used for a filter for Raman scattered light. FIG. 7 is a diagram for illustrating that a specific wavelength component is reflected by the fiber Bragg grating of FIG. 6.

As shown in FIG. 5, fiber laser engine 10 includes a plurality of semiconductor excitation light sources 1a and 1b, optical multiplexers 2a and 2b, an optical fiber Bragg grating (FBG HR 100%) 3, an optical fiber Bragg grating (FBG OC 10%) 4, an amplifying optical fiber 5, a Raman light reduction filter 6, a plurality of optical fibers 7a and 7b, and an output optical fiber 8.

The plurality of semiconductor excitation light sources 1a each output excitation light to be supplied to amplifying optical fiber 5. The excitation light has a wavelength capable of optically exciting amplifying optical fiber 5, e.g., a wavelength of 915 nm. The plurality of optical fibers 7a each propagate the excitation light output from a respective one of the plurality of semiconductor excitation light sources 1a and output the excitation light to optical multiplexer 2a.

Optical multiplexer 2a is composed for example of a tapered fiber bundle (TFB). Optical multiplexer 2a combines the excitation lights received from the plurality of optical fibers 7a to an optical fiber of a signal light port and outputs the combined light to amplifying optical fiber 5.

The plurality of semiconductor excitation light sources 1b, as an excitation light source, each output excitation light to be supplied to amplifying optical fiber 5. The excitation light has a wavelength capable of optically exciting amplifying optical fiber 5, e.g., a wavelength of 915 nm. The plurality of optical fibers 7b each propagate the excitation light output from a respective one of the plurality of semiconductor excitation light sources 1b and output the excitation light to optical multiplexer 2b.

As well as optical multiplexer 2a, optical multiplexer 2b is composed for example of a TFB. Optical multiplexer 2b combines the excitation lights received from the plurality of optical fibers 7b to an optical fiber of a signal light port and outputs the combined light to amplifying optical fiber 5.

Amplifying optical fiber 5 is a double cladding type optical fiber having a core portion, an inner cladding layer, and an outer cladding layer. The core portion is for example an ytterbium doped fiber (YDF) composed of quartz-based glass with ytterbium (Yb) ions as an amplification substance added thereto. The inner cladding layer covers an outer circumference of the core portion and is made for example of quartz-based glass. The outer cladding layer covers an outer circumference of the inner cladding layer and is made for example of resin.

The core portion of amplifying optical fiber 5 for example has a numerical aperture (NA) of 0.08 and is configured to propagate light emitted by optical excitation of Yb ions (and having a wavelength for example of 1070 nm) in a single mode. The core portion of amplifying optical fiber 5 has an absorption coefficient for example of 200 dB/m for a wavelength of 915 nm. Further, efficiency of conversion of power to laser light from excitation light input to the core portion is for example 70%.

Reflection means on the rear end side, or FBG 3, is connected between an optical fiber of a signal light port of optical multiplexer 2a and amplifying optical fiber 5. FBG 3 has a center wavelength for example of 1070 nm. FBG3 has a reflectance of about 100% for the center wavelength (1070 nm) and a wavelength band of a width of about 2 nm around the center wavelength. FBG 3 transmits most of light having a wavelength of 915 nm.

Reflection means on the output side, or FBG 4, is connected between an optical fiber of a signal light port of optical multiplexer 2b and amplifying optical fiber 5. FBG 4 has substantially the same center wavelength as that of FBG 3 (e.g., 1070 nm). FBG 4 has a reflectance of about 10% or more to 30% or less for the center wavelength (1070 nm), and has a reflection wavelength band with a full width at half maximum of about 1 nm. FBG 4 transmits most of light having a wavelength of 915 nm.

FBGs 3 and 4 are disposed at opposite ends, respectively, of amplifying optical fiber 5 and form an optical fiber resonator for light having a wavelength for example of 1070 nm.

Amplifying optical fiber 5 has Yb ions of the core portion optically excited by excitation light and emits light of a band including a wavelength of 1070 nm. The light having the wavelength of 1070 nm is oscillated as laser light by the optical amplification function of amplifying optical fiber 5 and the function of the optical resonator composed of FBGs 3 and 4.

Output optical fiber 8 is disposed on a side of optical multiplexer 2b opposite to FBG 4 and connected to an optical fiber of a signal light port of optical multiplexer 2b. The oscillated laser light is output from output optical fiber 8. Output optical fiber 8 is connected for example to delivery optical fiber 17 (FIG. 2). The laser light is propagated by delivery optical fiber 17 for a prescribed application.

The laser light oscillated from the optical fiber resonator composed of FBGs 3 and 4 includes Raman scattered light. Accordingly, in the present embodiment, Raman light reduction filter 6 reduces the Raman scattered light. Thus, the Raman scattered light in the laser light output from fiber laser engine 10 has a value limited for example to −40 dB or less. Furthermore, the Raman scattered light at the processing point of the workpiece has a value limited for example to −30 dB or less.

Raman light reduction filter 6 is disposed for example between optical multiplexer 2b and output optical fiber 8. Note that Raman scattered light is generated by laser light in an optical fiber of those configuring the optical fiber laser that propagates the laser light. The optical fiber that propagates the laser light is mainly amplifying optical fiber 5, FBG 4, an optical fiber configuring a signal light port of optical multiplexer 2b, output optical fiber 8, and an optical fiber interconnecting them together. Raman light reduction filter 6 has a function to selectively reduce the power of the generated Raman scattered light.

In the present embodiment, laser light has a wavelength for example of 1070 nm, and accordingly, Raman scattered light has a wavelength of about 1120 nm. Raman light reduction filter 6 has a transmittance for example of −30 dB or less around 1120 nm. Therefore, when Raman scattered light is input to Raman light reduction filter 6, Raman scattered light has its power selectively and significantly reduced.

Raman light reduction filter 6 is composed for example of a slant fiber Bragg grating (FBG). The slant FBG for example selectively reflects Raman scattered light and causes the Raman scattered light to leak outside the core of the FBG to reduce the power of the Raman scattered light.

As shown in FIGS. 6(A) and 6(B), the FBG comprises an optical fiber having a core 6a with refractive index modulation (a diffraction grating 6d) formed therein. Note that core 6a has an outer circumference covered with a cladding layer 6b, and cladding layer 6b has an outer circumference covered with a buffer layer 6c.

When the FBG has core 6a with an effective refractive index n and a grating (diffraction grating 6d) with an interval, referred to as a grating period, L, the FBG only reflects an optical signal having a wavelength that matches the period of diffraction grating 6d (λ_{B}=2 nL) and the FBG transmits optical signals having other wavelengths.

As a result, when incident light having a wavelength band as shown in FIG. 7(A) is transmitted through core 6a of an optical fiber shown in FIG. 7(B) and passes through diffraction grating 6d of the FBG, a component of a specific wavelength (λ_{B}) proportional to interval L of diffraction grating 6d is reflected. Components other than the specific wavelength (λ_{B}) pass through diffraction grating 6d. Therefore, the light transmitted through diffraction grating 6d has a wavelength band having the component of the specific wavelength (λ_{B}) alone removed, as shown in FIG. 7(C). Note that the specific wavelength (λ_{B}) is called Bragg wavelength.

Note that the slant FBG has a grating direction (a direction perpendicular to a plane in which a refractive index increases) inclined (or slanted) from the axis of the optical fiber by diffraction grating 6d formed in core 6a of the optical fiber. This allows the light of the component of the specific wavelength (λ_{B}) to leak outside of core 6a.

Thus, Raman scattered light can be caused to leak outside of core 6a by configuring Raman light reduction filter 6 by a slant FBG and adjusting interval L of diffraction grating 6d to match a specific wavelength (λ_{B}) with the wavelength of the Raman scattered light. Thus the power of the Raman scattered light in the optical fiber can be reduced.

### <Laser Processing Method>

A laser processing method of the present embodiment will now be described with reference to FIGS. 2 and 5 to 8.

As shown in FIG. 5, in the laser processing method of the present embodiment, the plurality of semiconductor excitation light sources 1a and 1b each output excitation light. The excitation lights output from the plurality of semiconductor excitation light sources 1a are combined together by optical multiplexer 2a, and thereafter transmitted through FBG 3 and output to amplifying optical fiber 5. The excitation lights output from the plurality of semiconductor excitation light sources 1b are combined together by optical multiplexer 2b, and thereafter transmitted through FBG 4 and output to amplifying optical fiber 5.

Amplifying optical fiber 5 has Yb ions of the core portion optically excited by excitation light and emits light of a band including a wavelength for example of 1070 nm. The light having the wavelength of 1070 nm is oscillated as laser light by the optical amplification function of amplifying optical fiber 5 and the function of the optical resonator composed of FBGs 3 and 4.

The oscillated laser light has a wavelength of a 1 μm band (1 μm or more and less than 2 μm), and has a wavelength for example of 1070 nm.

The oscillated laser light includes Raman scattered light. Accordingly, in the present embodiment, the Raman scattered light contained in the laser light is reduced by Raman light reduction filter 6. Specifically, diffraction grating 6d shown in FIGS. 6 and 7 slants a grating direction from the axis of the optical fiber to cause the Raman scattered light to leak outside of core 6a.

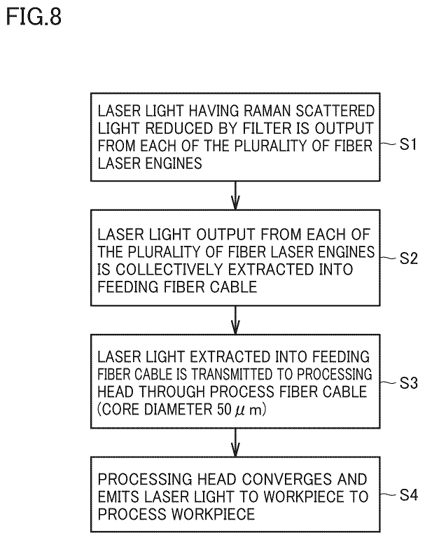

Thus, laser light having Raman scattered light reduced by Raman light reduction filter 6 is output from each of the plurality of fiber laser engines 10 (step S1: FIG. 8).

As shown in FIG. 2, the laser light output from each of the plurality of fiber laser engines 10 is collectively extracted into feeding fiber cable 12 having a core diameter of 50 μm (step S2: FIG. 8).

The laser light extracted into feeding fiber cable 12 is transmitted to processing head 20 through process fiber cable 16 having a core diameter of 50 μm (step S3: FIG. 8). Processing head 20 converges and emits the laser light to the workpiece (step S4: FIG. 8). Thus, the workpiece is processed by the laser processing apparatus.

When the laser light is emitted to the workpiece, an inert gas (e.g., nitrogen gas, argon gas, or the like) is blown to the workpiece as an assist gas. The laser light at a processing point of the workpiece has a spot diameter for example of 60 μm or more and 150 μm or less. The laser light's focal point position is preferably set at any position between a surface of the workpiece and the center in thickness of the workpiece.

Thus, in the present embodiment, laser light having a wavelength of a 1 μm band (e.g., 1070 nm) is guided to processing head 20 by process fiber cable 16 having a core diameter of 50 μm, and a workpiece is processed with laser light with Raman scattered light having a value of −30 dB or less at the processing point.

Furthermore, in order to set the value of the Raman scattered light at the processing point to −30 dB or less, a value of Raman scattered light output from fiber laser engine 10 is set to −40 dB or less by Raman light reduction filter 6. In addition, an oscillation output of each of the plurality of fiber laser engines 10 is limited based on the length of process fiber cable 16 that transmits the laser light output from fiber laser engine 10.

Specifically, when process fiber cable 16 having a core diameter of 50 μm has a length of 10 m, the plurality of fiber laser engines 10 each have an oscillation output adjusted so that the plurality of fiber laser engines provide a total maximum output of 9 kW. When process fiber cable 16 having a core diameter of 50 μm has a length of 20 m, the plurality of fiber laser engines 10 each have an oscillation output adjusted so that the plurality of fiber laser engines provide a total maximum output of 8 kW.

### <Effect>

The present embodiment has an effect, as described below:

When laser light is used to cut a metal material, the laser light is converged to have a spot diameter of 60 μm to 800 μm and thus increased in energy density to heat the workpiece to a temperature equal to or higher than the metal's melting point. Further, in such a processed state, cutting is performed while material is removed by blowing an assist gas to molten pool.

When cutting a soft thick steel plate, oxygen gas is used as an assist gas to perform a cutting process by utilizing heat of oxidation reaction. When a relatively thin plate is cut and generation of oxide film on a cut surface is disfavored, nitrogen gas is used as an assist gas.

When a soft thick steel plate is cut with laser light having a wavelength of a 1 μm band (1 μm or more and less than 2 μm), the laser light is absorbed by the workpiece at a rate higher than a carbon dioxide gas laser having a wavelength of 10.6 μm is. Therefore, when oxygen gas is used as an assist gas and a spot diameter is reduced, self-burning is easily caused, and stable cutting is thus difficult.

Accordingly, when cutting a thick plate, the laser light has a spot diameter increased to enlarge a kerf in width to cause molten pool to better flow.

On the other hand, when a thin plate is cut with oxygen used as an assist gas, oxidation reaction rate serves as a rate-determining factor, and the thin plate is cut at a slow rate. Accordingly, when cutting the thin plate, an inert gas such as nitrogen may be used as the assist gas. When cutting the thin plate with nitrogen gas used as the assist gas, it is necessary to minimize the laser light's spot diameter to increase energy density to increase the cutting speed.

The laser light's spot diameter is calculated by multiplying the core diameter of process fiber cable 16 by the optical magnification of processing head 20 (i.e., spot diameter=core diameter x optical magnification). The optical magnification is expressed by fL/fC, where, as shown in FIG. 2, in processing head 20, the collimator has a focal length fC and the condensing lens has a focal length fL. Therefore, in order to reduce the laser light's spot diameter, it is necessary to reduce the core diameter of the process fiber cable and the optical magnification.

However, even when a high-power fiber laser oscillator is used and the process fiber cable has a core diameter reduced to 50 μm, which is the minimum core diameter currently available, it has been impossible so far to increase speed of cutting a workpiece.

Accordingly, the present inventors have diligently studied why it is impossible to increase speed of cutting a workpiece. As a result, the present inventors have found that when the fiber laser oscillator's power is increased, Raman scattered light contained in laser light has an increased value and speed of cutting a workpiece cannot be increased.

According to the present embodiment, based on the above findings, as shown in FIG. 5, the plurality of fiber laser engines 10 are each provided with Raman light reduction filter 6. Raman light reduction filter 6 reduces Raman scattered light in laser light. This allows a workpiece to be processed at an increased speed by increasing power of a fiber laser oscillator using process fiber cable 16 having a small core diameter of 50 μm.

Raman means a phenomenon in which when light is incident on a substance, light having a wavelength different from that of the incident light is included in scattered light. In a conventional laser processing apparatus, Raman scattered light is amplified as it is emitted from semiconductor excitation light source 1a and proceeds toward nozzle unit 20D. Furthermore, when a reflection of laser light caused by the workpiece enters process fiber cable 16 via processing head 20, Raman scattered light is further amplified as the reflection of light returns to semiconductor excitation light source 1a.

The Raman scattered light returned by the reflection interferes with laser light of a wavelength required for cutting the workpiece (e.g., 1080 nm), and causes variation in output of the laser light. Furthermore, the laser light of the wavelength required for cutting the workpiece is returned into the resonator by FBG 3. However, since the Raman scattered light has a wavelength passing through FBG 3, it reaches and damages semiconductor excitation light source 1a.

In the present embodiment, Raman light reduction filter 6 can reduce a value of Raman scattered light. This allows process fiber cable 16 to receive reduced Raman scattered light even when Raman scattered light included in a reflection of light caused by the workpiece enters process fiber cable 16. This can suppress variation in output of a laser caused by interference of Raman scattered light with laser light of a wavelength required for cutting a workpiece, and can also suppress damage caused by Raman scattered light to semiconductor excitation light source 1a.

Furthermore, according to the present embodiment, Raman light reduction filter 6 shown in FIG. 5 has a configuration to cause Raman scattered light to leaked out of a core of a fiber cable. This can reduce Raman scattered light in laser light.

Further, when process fiber cable 16 is increased in length, Raman scattered light in laser light increases and speed of processing a workpiece decreases, and semiconductor excitation light sources 1a and 1b may be damaged.

For this matter, according to the present embodiment, as shown in FIG. 2, controller 40 that limits an oscillation output at each of the plurality of fiber laser engines 10 based on the length of process fiber cable 16 is provided. This allows Raman scattered light to be controlled to have a value of −30 dB or less at a processing point, regardless of the length of process fiber cable 16, and can thus prevent Raman scattered light from damaging semiconductor excitation light sources 1a and 1b.

For this matter, according to the present embodiment, as shown in FIG. 2, controller 40 that limits an oscillation output at each of the plurality of fiber laser engines 10 is provided. This allows Raman scattered light to be controlled to have a value of −30 dB or less at a processing point, depending on the length of process fiber cable 16, and can thus prevent Raman scattered light from damaging semiconductor excitation light sources 1a and 1b.

Furthermore, the fiber laser engine has a minimum power that is about 10% of rated power, and accordingly, a fiber laser engine having power of 1500 W has a range of 150 W to 1500 W as a power adjustable range. Accordingly, for example an oscillator which is a combination of four fiber laser engines each having a power of 1500 W and thus has a rated power of 6000 W will have a power adjustable range of 600 W to 6000 W.

On the other hand, it is necessary to narrow power to about 300 W when scribing a workpiece or marking on a surface of the workpiece. This is, however, out of the power adjustable range for a high-power oscillator, and scribing or marking cannot be performed.

For this matter, according to the present embodiment, as shown in FIG. 2, controller 40 selects among the plurality of fiber laser engines 10 fiber laser engine 10 which causes laser light to oscillate and fiber laser engine 10 which does not cause laser light to oscillate. Thus, when scribing or marking, the number of oscillating fiber laser engines 10 can be limited to limit an oscillation output of the plurality of fiber laser engines 10.

Furthermore, according to the present embodiment, laser light having a wavelength of a 1 μm band is used, an inert gas is used as an assist gas, and a spot diameter at a processing point of a workpiece is 60 μm or more and 150 μm or less.

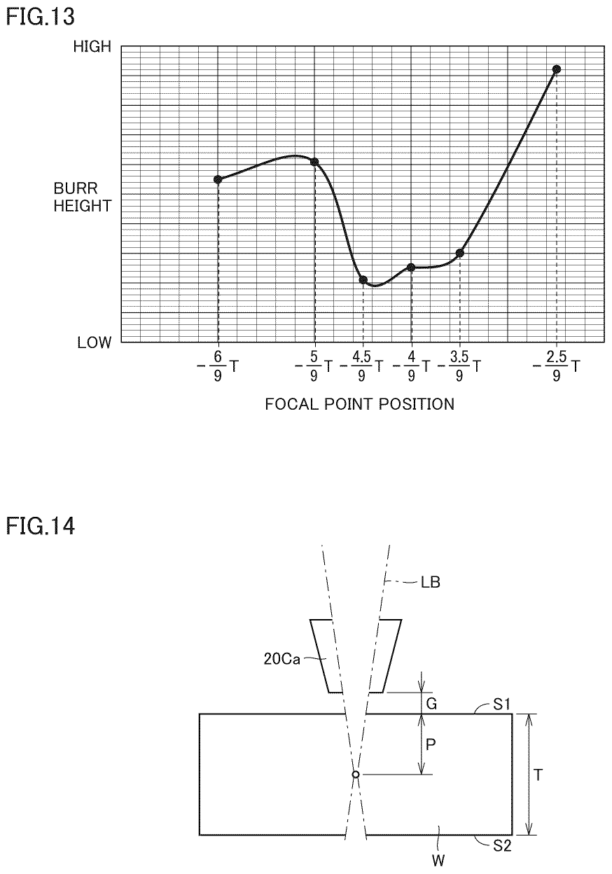

Furthermore, according to the present embodiment, as shown in FIG. 14, laser light's focal point is set at any position between a surface MS of a workpiece W and the center in thickness T of workpiece W. This can keep speed of processing workpiece W high and reduce height of burr produced on a back side of a cut surface of workpiece W.

Furthermore, according to the present embodiment, Raman scattered light at a processing point of a workpiece has a value of −30 dB or less. This allows a workpiece to be processed at an increased speed by increasing the power of fiber laser oscillator 15 using process fiber cable 16 having a small core diameter (50 μm).

### EMBODIMENTS

Specific considerations done by the present inventors will now be described in the form of example.

### [Cutting Speed]

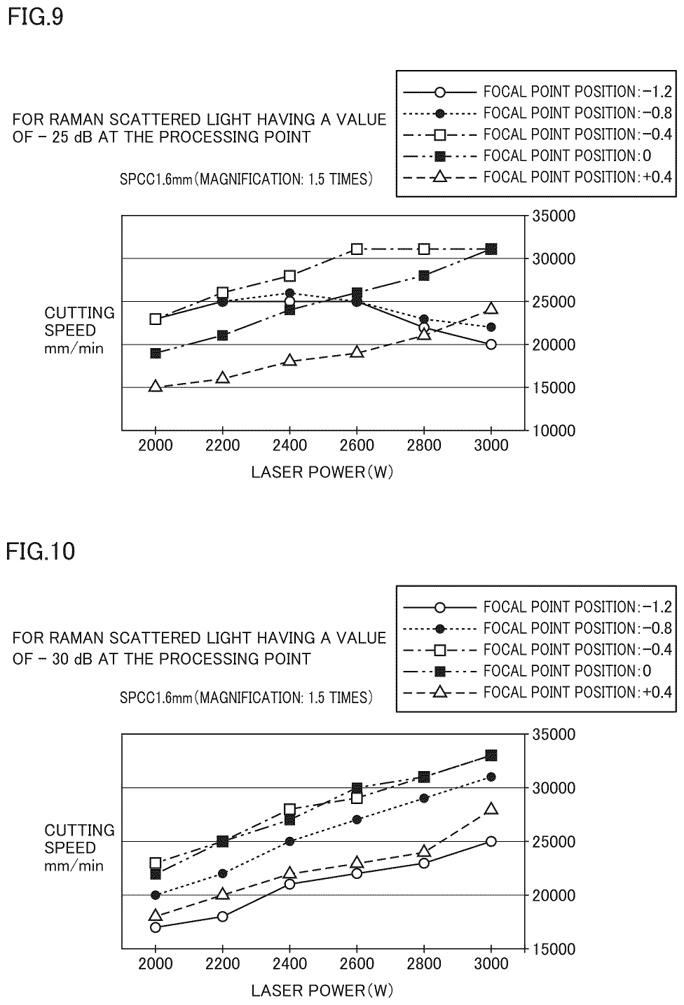

The present inventors have conducted a variety of investigations for why speed of cutting a workpiece cannot be increased. In the investigations, the present inventors have variously changed a value of Raman scattered light at a processing point, and examined a relationship between laser output for each value of Raman scattered light and speed of cutting the workpiece. As a part of the results, FIG. 9 and FIG. 10 show results when Raman scattered light at the processing point has values of −25 dB and −30 dB.

In this investigation, for Raman scattered light having a value of −25 dB, an optical magnification (fL/fC) of 1.5 times was set, and for Raman scattered light having a value of −30 dB, an optical magnification (fL/fC) of 1.25 times was set.

For both Raman scattered light having a value of −25 dB at the processing point and Raman scattered light having a value of −30 dB at the processing point, an SPCC specified in JIS(Japanese Industrial Standards) G 3141 (thickness: 1.6 mm) was used as the workpiece. Excitation light output from the semiconductor excitation light source had a wavelength having a value of 915 nm, and oscillated laser light had a wavelength having a value of 1070 nm. The feeding fiber cable and the process fiber cable each had a core diameter of 50 μm. Nitrogen was used as the assist gas.

Further, the laser light's focal point position was changed in a range of −1.2 to +0.4 from a surface of the workpiece. A subtraction sign “−” preceding a numerical value representing a focal point position indicates that the focal point position is inside the workpiece (i.e., in-focus). On the other hand, an addition sign “+” preceding a numerical value representing a focal point position indicates that the focal point position is outside the workpiece (i.e., defocus).

As shown in FIG. 9, for Raman scattered light having a value of −25 dB at the processing point, when laser power was increased, cutting speed dropped from a predetermined laser power value for focal point positions of −0.8 and −0.4. In contrast, as shown in FIG. 10, for Raman scattered light having a value of −30 dB at the processing point, even when laser power was increased, cutting speed did not drop for a set range of laser power.

From these investigations, it has been found that when the process fiber cable is 50 μm, and Raman scattered light at a processing point has a value reduced to −30 dB or less, increasing a laser power to 2400 W or more also increases speed of cutting the workpiece in proportion to the increased laser power. This is findings unconventional and obtained for the first time by the present inventors.

Based on the findings, in the present disclosure, the plurality of fiber laser engines 10 each have Raman light reduction filter 6 that suppresses generation of Raman scattered light. This allows Raman scattered light at a processing point to have a value reduced to −30 dB or less while process fiber cable 16 has a core diameter reduced to 50 μm. This allows a workpiece to be processed at a processing speed that has not been conventionally achieved.

The value of the Raman scattered light at the processing point is detected by an optical spectrum analyzer 104 as shown in FIG. 11. Optical spectrum analyzer 104 receives diffuse light of laser light that is emitted from a laser output connector 101 to a power meter (a power damper) 102 through a pickup fiber 103. Optical spectrum analyzer 104 analyzes the received diffuse light to detect value of the Raman scattered light at the processing point.

### [Height of Burr]

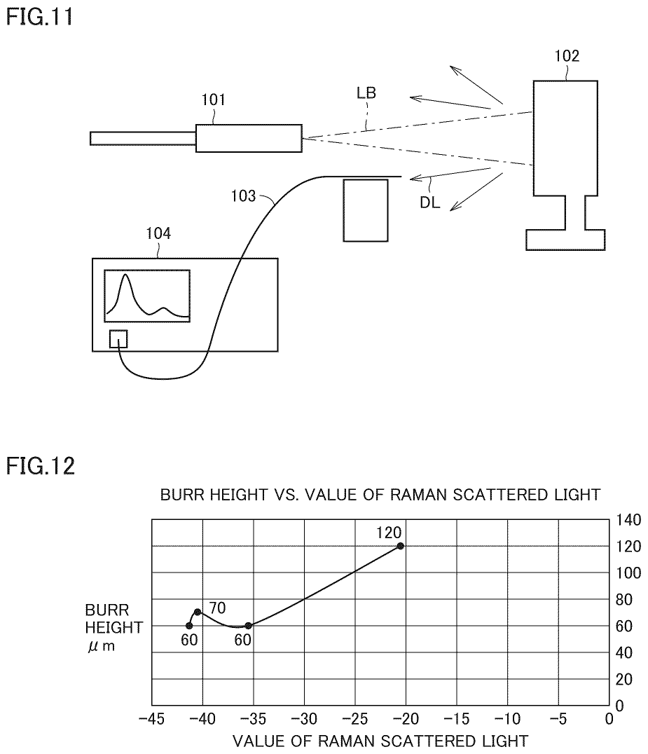

When a thin plate is cut while using nitrogen gas as an assist gas, there is a case where burr is produced on a back side of a cut surface of the workpiece. The present inventors investigated a relationship between a value of Raman scattered light at a processing point and height of burr produced on a back side of a cut surface due to cutting. A result thereof is shown in FIG. 12.

In this investigation, SPHC specified in JIS G 3131 (thickness: 6 mm) was used as a workpiece. Excitation light output from the semiconductor excitation light source had a wavelength having a value of 915 nm, and oscillated laser light had a wavelength having a value of 1070 nm. The feeding fiber cable and the process fiber cable each had a core diameter of 50 μm. The workpiece was cut at a speed of 3.5 m/min. Laser power was set to 5 kW, 5.6 kW, 6 KW, and 8 kW.

As shown in FIG. 12, for laser power of 5.6 kW, Raman scattered light at a processing point had a value of −20.5 dB, and burr height was 120 μm. For laser power of 5 KW, Raman scattered light at the processing point had a value of −35.5 dB, and burr height was 60 μm. For laser power of 6 KW, Raman scattered light at the processing point had a value of −41.3 dB, and burr height was 60 μm. For laser power of 8 kW, Raman scattered light at the processing point had a value of −40.5 dB, and burr height was 70 μm.

From this investigation, it has been found that Raman scattered light having a value of −30 dB or less at a processing point allows height of burr produced on a workpiece to be suppressed to 80 μm or less.

The present inventors also investigated a relationship between laser light's focal point position with respect to a workpiece and height of burr. A result thereof is shown in FIG. 13.

In this investigation, as shown in FIG. 14, a gap G between a tip of a nozzle 20 Da of processing head 20 and surface MS of the workpiece was set to 0.5 mm. SS specified in JIS G 3101 (thickness: 9 mm) was used as workpiece W. Excitation light output from the semiconductor excitation light source had a wavelength having a value of 915 nm, and oscillated laser light had a wavelength having a value of 1070 nm. The feeding fiber cable and the process fiber cable each had a core diameter of 50 μm. Raman scattered light at a processing point had a value set to −30 dB or less. Nitrogen was used as the assist gas. Laser light's focal point position was in-focus with respect to workpiece W and changed from −2.5 T/9 to −6 T/9 with respect to thickness T of workpiece W.

As shown in FIG. 13, when the focal point position was −4.5 T/9, burr produced on a back side of a cut surface had a minimal height. Furthermore, a focal point position of −4.5 T/9 or more and −3.5 T/9 or less allows height of burr to be suppressed more than other focal point positions.

Furthermore, in order to cut a thin plate at high speed, it is preferable to minimize laser light's spot diameter. Accordingly, in order to cut the thin plate at high speed, it is preferable that the laser light's focal point position be set at surface MS of workpiece W.

From these investigations, it has been found that when cutting a workpiece while using nitrogen gas as an assist gas, with cutting speed and burr height considered, it is preferable that the laser light's focal point position be set at any position from surface MS of workpiece W to the center in thickness of workpiece W (i.e., −4.5 T/9). Further, when reduction of height of burr is considered, it has been found that it is preferable that the focal point position be set at any position of −4.5 T/9 or more and −3.5 T/9 or less.

It should be understood that the presently disclosed embodiments and examples are illustrative and not restrictive in any respect. The scope of the present invention is defined by the terms of the claims, rather than the description above, and is intended to include any modifications within the meaning and scope equivalent to the terms of the claims.

### REFERENCE SIGNS LIST

1a, 1b semiconductor excitation light sources, 2a, 2b optical multiplexer, 5 amplifying optical fiber, 6 Raman light reduction filter, 6a, 12a, 16a core, 6b, 12b, 16b cladding layer, 6c buffer layer, 6d diffraction grating, 7a, 7b optical fiber, 8 output optical fiber, 10 fiber laser engine, 11 beam combiner module, 12 feeding fiber cable, 13 splice box, 13a fused portion, 15 fiber laser oscillator, 16 process fiber cable, 17 delivery optical fiber, 20 processing head, 20A connector unit, 20B collimator unit, 20C lens unit, 20D nozzle unit, 20 Da nozzle, 20E beam diameter control unit, 22, 24, 25a, 25b, 27 protective glass, 23 collimator lens, 25 protective lens, 26 conversing lens, 28, 29 lens, 30 laser processing apparatus, 30F, 31F front surface, 31 cabin, 31S side surface, 32 gull wing door, 33 openable and closable ceiling door, 34 first console panel, 35 second console panel, 36 monitoring window, 37 pallet changer, 40 controller, 41, 43 lens driver, 42 operation unit, 101 laser output connector, 103 pickup fiber, 104 optical spectrum analyzer, M, W workpiece, MS surface.

1. A laser processing apparatus that processes a workpiece made of a metal material, comprising:
a plurality of fiber laser engines;
a feeding fiber cable that collectively extracts laser light generated by each of the plurality of fiber laser engines;
a processing head that converges and emits laser light to the workpiece; and
a process fiber cable that transmits the laser light extracted by the feeding fiber cable to the processing head,
a core diameter of the feeding fiber cable and a core diameter of the process fiber cable being equal and 50 μm;
the plurality of fiber laser engines each having a filter that reduces a value of Raman scattered light in laser light.

2. The laser processing apparatus according to claim 1, wherein the filter has a configuration that causes Raman scattered light to leak out of a core of a fiber cable.

3. The laser processing apparatus according to claim 1, further comprising a controller that limits an oscillation output at each of the plurality of fiber laser engines, based on a length of the process fiber cable, to allow Raman scattered light to have a value of −30 dB or less at a processing point of the workpiece.

4. The laser processing apparatus according to claim 1, further comprising a controller that selects among the plurality of fiber laser engines a fiber laser engine which causes laser light to oscillate and a fiber laser engine which does not cause laser light to oscillate.

5. A laser processing method for processing a workpiece made of a metal material using a laser processing apparatus, the laser processing apparatus comprising:
a plurality of fiber laser engines;
a feeding fiber cable that collectively extracts laser light generated by each of the plurality of fiber laser engines;
a processing head that converges and emits laser light to the workpiece; and
a process fiber cable that transmits the laser light extracted by the feeding fiber cable to the processing head,
a core diameter of the feeding fiber cable and a core diameter of the process fiber cable being equal and 50 μm;
the plurality of fiber laser engines each having a filter that reduces a value of Raman scattered light in laser light, the laser processing method comprising:
causing the laser light to have a wavelength of a 1 μm band;
selecting an inert gas as an assist gas; and
selecting a spot diameter at a processing point of the workpiece to be 60 μm or more and 150 μm or less.

6. The laser processing method according to claim 5, wherein a focal point of the laser light is set at a position between a surface of the workpiece and a center in thickness of the workpiece.

7. The laser processing method according to claim 5, wherein Raman scattered light at a processing point of the workpiece has a value of −30 dB or less.

8. The laser processing method according to claim 5, wherein an oscillation output at each of the plurality of fiber laser engines is limited, based on a length of the process fiber cable, to allow Raman scattered light to have a value of −30 dB or less at the processing point of the workpiece.

9. The laser processing method according to claim 5, wherein a fiber laser engine which causes laser light to oscillate and a fiber laser engine which does not cause laser light to oscillate are selected from the plurality of fiber laser engines.
